(19) United States
(12) Patent Application Publication
(10) Pub. No.: US 2002/0016205 A1
(43) Pub. Date: Feb. 7, 2002

(54) Game mastery support apparatus, terminal apparatus, and computer readable medium having recorded thereon processing program for activating the game mastery support apparatus

(75) Inventors: Akihiko Nagata, Tokyo (JP); Shigeru Fukutake, Tokyo (JP); Yoshitatsu Okamoto, Tokyo (JP)

Correspondence Address: SUGHRUE, MION, ZINN,, MACPEAK & SEAS, PLLC, 2100 Pennsylvania Avenue, N.W., Washington, DC, 20037, US

(73) Assignee: KONAMI CORPORATION

(21) Appl. No.: 09/919,807

(22) Filed: Aug. 2, 2001

(30) Foreign Application Priority Data
Aug. 7, 2000 (JP) P.2000-237830

(51) Int. Cl. G06F 19/00

(52) U.S. Cl. 463/40

(57) ABSTRACT

First stage mastery information is for mastering a first stage of a game. Similarly, second stage mastery information is for mastering a second stage of the game. Further, the n^{th} stage mastery information is for mastering the n^{th} stage of the game. In relation to mastery status flags, when only the first stage flag assumes “1,” a game mastery support apparatus detects that the first stage has already been mastered, and distributes second stage mastery information (“b”).

### BACKGROUND OF THE INVENTION

1. Field of the Invention

The present invention relates to a game mastery support apparatus for supporting mastery of a game. Further, the present invention relates to a terminal apparatus having a game execution function. Furthermore, the present invention relates to a recording medium, such as a computer readable medium, having recorded thereon a processing program for activating the game mastery support apparatus.

The present application is based on Japanese Patent Application No. 2000-237830, which is incorporated herein by reference.

2. Description of the Related Art

Games for use with a variety of TV game machines are presently provided. Some of the games are very complicated for players to master the final stages. For this reason, some of players play the complicated games while taking, as clues, information described in mastery books for mastering such the games.

However, if such a mastery book becomes thicker, it may be difficult for players to transport or store such the book. Further, since such mastery books are edited without consideration of an area or a stage of a game to which a player has proceeded, necessary mastery information that the player desires is not actually available in timely fashion in the mastery books.

### SUMMARY OF THE INVENTION

The present invention has been conceived to solve the aforementioned problems, and is aimed at providing a game mastery support apparatus and a terminal apparatus which enable a player to receive mastery information. Further, the present invention is aimed at providing a recording medium, such as a computer readable medium, having recorded thereon a processing program for enabling a player to receive mastery information.

According to a first aspect of the present invention, there is provided a game mastery support apparatus which supports mastery of a game. The game mastery support apparatus comprises a distribution device which distributes mastery information for mastering a game to a terminal apparatus having a game execution function.

In accordance with the first aspect of the present invention, mastery information for mastering a game is distributed to a terminal apparatus having a game execution function. Accordingly, the player can receive the mastery information.

According to a second aspect of the present invention, it is preferable that the distribution device distributes the mastery information according to mastery status information, which is obtained from the terminal apparatus and indicates a stage of the game to which a player has proceeded.

In accordance with the second aspect of the present invention, mastery information necessary for the player can be acquired in timely fashion.

According to a third aspect of the present invention, the mastery status information from the terminal apparatus may include flag information indicating an area or a stage of the game to which the player has proceeded.

According to a fourth aspect of the present invention, the game mastery support apparatus may further comprise a ranking information distribution device which distributes ranking information pertaining to a rank of a player in the game.

According to a fifth aspect of the present invention, the ranking information distribution device may include an accumulator which accumulates the mastery status information from the terminal apparatus for each player's identifier, a determining device which determines a rank of a corresponding user with reference to the accumulated mastery status information, and a distributor which distributes ranking information pertaining to the determined rank.

According to a sixth aspect of the present invention, the terminal apparatus may comprise a first terminal device having a game execution function, and a second terminal device displaying received mastery information within a display area thereof. In this case, it is preferable that the game mastery support apparatus further comprises a receiver which receives, from the first terminal device, mastery status information representing a game stage to be mastered, and a distributing device which distributes, to the second terminal device specified as a destination, the mastery information and the ranking information according to the mastery status information from the first terminal device.

In accordance with the sixth aspect of the present invention, a player can play a game while viewing a game screen of the first terminal device, with reference to the mastery information displaying on the display area of the second terminal device. A sufficient display area for mastery information can be ensured, thus preventing the player from encountering difficulty in viewing the game screen.

According to a seventh aspect of the present invention, the terminal apparatus may be a portable device. The first terminal apparatus and the second terminal apparatus may be portable devices.

According to an eighth aspect of the present invention, there is provided a terminal apparatus which receives information distributed by a game mastery support apparatus for supporting mastery of a game, and which has a game execution function. The terminal apparatus comprises a display screen, and a processing section which receives, from the game mastery support apparatus, distributed mastery information for mastering a game, and which displays the mastery information on the display screen. Accordingly, mastery information can be displayed on the display screen of the terminal apparatus.

According to a ninth aspect of the present invention, it is preferable that the processing section receives, from the game mastery support apparatus, distributed ranking information pertaining to a rank of a player in the game, and displays the ranking information on the display screen.

According to a tenth aspect of the present invention, the terminal apparatus may further comprise a first terminal device which has the game execution function, and which sends, to the game mastery support apparatus, mastery status information representing a game stage to be mastered, and a second terminal device which receives information distributed by the game mastery support apparatus, and which is specified as a destination of the mastery information, wherein the second terminal device includes the display screen, and the processing section receiving, from the game mastery support apparatus, the mastery information for mastering the game, and displaying the mastery information on the display screen.

In accordance with the tenth aspect of the present invention, a player can play a game while viewing a game screen of the first terminal device, with reference to the mastery information displaying on the display area of the second terminal device. A sufficient display area for mastery information can be ensured, thus preventing the player from encountering difficulty in viewing the game screen.

According to an eleventh aspect of the present invention, the terminal apparatus may be a portable device. The first terminal apparatus and the second terminal apparatus may be portable devices.

According to a twelfth aspect of the present invention, there is provided a computer readable medium having recorded thereon a processing program for activating a game mastery support apparatus for supporting mastery of a game. The processing program comprises a distributing routine for distributing mastery information for mastering a game to a terminal apparatus having a game execution function.

When a computer executes the processing program, there is executed processing routine for distributing mastery information for mastering a game to a terminal apparatus having a game execution function. The player can receive distributed mastery information.

It should be noted that the aforementioned computer readable medium includes a recording medium that enables reading and recording of digital contents. More specifically, such the computer readable medium includes, for example, a semiconductor recording medium such as a ROM (i.e., Read Only Memory), a semiconductor IC (i.e., Integrated Circuit), etc., an optical recording medium such as a DVD-ROM (i.e., Digital Versatile Disk-Read Only Memory), a CD-ROM (i.e., Compact Disc-Read Only Memory), etc., a magnetic recording medium such as a flexible disk etc., and a magneto-optical recording medium such as an MO (i.e., Magneto Optical Disk) etc.

According to a thirteenth aspect of the present invention, there is provided a method for distributing, via a communications network, game mastery information from a game mastery support apparatus to a terminal apparatus having a game execution function in accordance with a request from the terminal apparatus, the method comprising the steps of:

storing, in the terminal apparatus, user information items including a game title, mastery information flag pertaining to a game stage to be mastered, a user identifier, and personal user information;

transmitting the user information items to the game mastery support apparatus;

causing a processing section of the game mastery support apparatus to retrieve mastery information corresponding to the received game title and mastery information flag from a mastery information table of the game mastery support apparatus;

storing the received mastery information flag as mastery status information to a mastery status management table of the game mastery support apparatus on a per-user-identifier basis;

causing the processing section of the game mastery support apparatus to retrieve the game information items corresponding to the received game title from a game title data base group of the game master support apparatus;

causing the processing section to store the received personal user information as customer information database;

determining a rank of a corresponding user with reference to the stored mastery status information; and

distributing, to the terminal apparatus, mastery information corresponding to mastery status information on the game stage to be mastered, and the determined user rank information.

According to a fourteenth aspect of the present invention, the method may further comprise the steps of:

distributing rarity added value information from the game mastery support apparatus to the terminal apparatus of a higher-ranked user; and

storing a mastery status information distribution history in the game mastery support apparatus on a per-user basis, thereby customizing a delivery status for each user.

### BRIEF DESCRIPTION OF THE DRAWINGS

The above and other objects and advantages of the present invention will become more apparent by describing in detail preferred embodiments thereof with reference to the accompanying drawings, wherein:

FIG. 1 is a block diagram showing an embodiment of a game mastery support system 1 according to the present invention;

FIG. 2 is a block diagram showing a terminal apparatus 100;

FIG. 3 is a descriptive view showing a mastery status flag table 110;

FIG. 4 is a descriptive view showing a mastery status flag and mastery information;

FIG. 5 is a block diagram showing a game mastery support apparatus 300;

FIG. 6 is a descriptive view showing a mastery information table 351;

FIG. 7 is a flowchart for explaining Operation Example 1;

FIG. 8 is a descriptive view showing mastery information appearing on a display area 57 of a display device 56;

FIG. 9 is a descriptive view showing a mastery status management table 352;

FIG. 10 is a flowchart for explaining Operation Example 2;

FIG. 11 is a descriptive view showing mastery information and ranking information appearing on the display area 57 of the display device 56;

FIG. 12 is a block diagram showing hardware configuration of the game mastery support apparatus 300;

FIG. 13 is a block diagram showing another embodiment of the present invention;

FIG. 14 is a block diagram showing one example of a business method of distributing game mastery information; and

FIG. 15 is a flowchart for explaining the operation of the business method shown in FIG. 14.

### DETAILED DESCRIPTION OF THE PREFERRED EMBODIMENTS

Preferred embodiments of the present invention will be described hereinbelow with reference to the accompanying drawings.

1. Construction

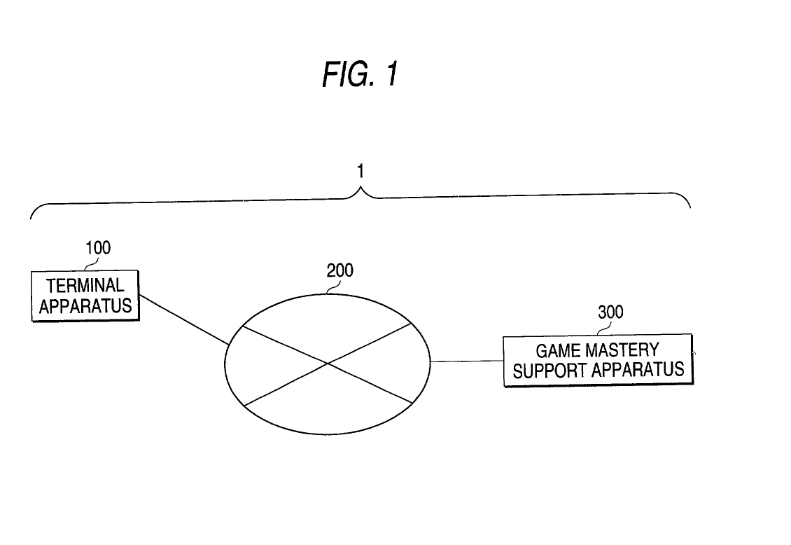

FIG. 1 is a block diagram showing a preferred embodiment of a game mastery support system 1 according to the present invention. The game mastery support system 1 has a terminal apparatus 100 owned by a user who acts as a player, and a game mastery support apparatus 300 which supports mastery of a game by distributing mastery information. The terminal apparatus 100 and the game mastery support apparatus 300 are connected to a communications network 200 so as to be able to exchange required information. Naturally, a plurality of terminal apparatuses 100 may be employed. For the sake of facilitation of explanation, one terminal apparatus 100 is employed. Further, the communications network 200 is embodied through use of, e.g., the Internet, a private line, etc.

2. Construction of the terminal apparatus 100

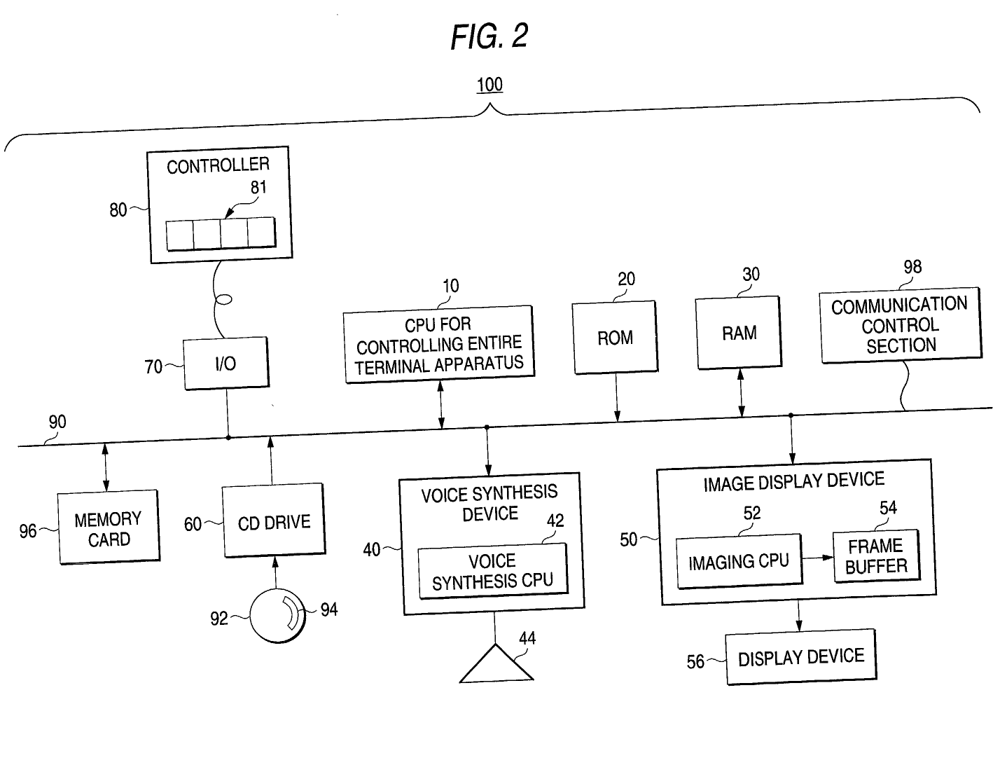

As shown in FIG. 2, the terminal apparatus 100 has a game execution function and comprises a CPU 10 for controlling the entire terminal apparatus 100; ROM 20 having recorded thereon a basic software such as an operating system (OS) etc.; RAM 30 in which a work area is to be formed; a voice synthesis device 40; an image display device 50; a CD drive 60; a controller 80 connected to the terminal apparatus 100 via an I/O device 70; a memory card 96; and a communication control section 98. These construction elements are interconnected by a bus 90 so as to be able to exchange required information.

The voice synthesis device 40 has a voice synthesis CPU 42. The voice synthesis CPU 42 causes a loudspeaker 44 to output an effect sound in accordance with a voice control signal output from the CPU 10. Further, the image display device 50 has an imaging CPU 52 and a frame buffer 54 and is connected to a display device 56 embodied in a home TV set etc. The imaging CPU 52 de-archives, into the frame buffer 54, image data corresponding to a display control signal transmitted from the CPU 10. As a result thereof, a desired display image appears on the display device 56.

The controller 80 is provided with switches 81 including a plurality of switches. Menu selection or movement of a character can be effected by actuation of switches.

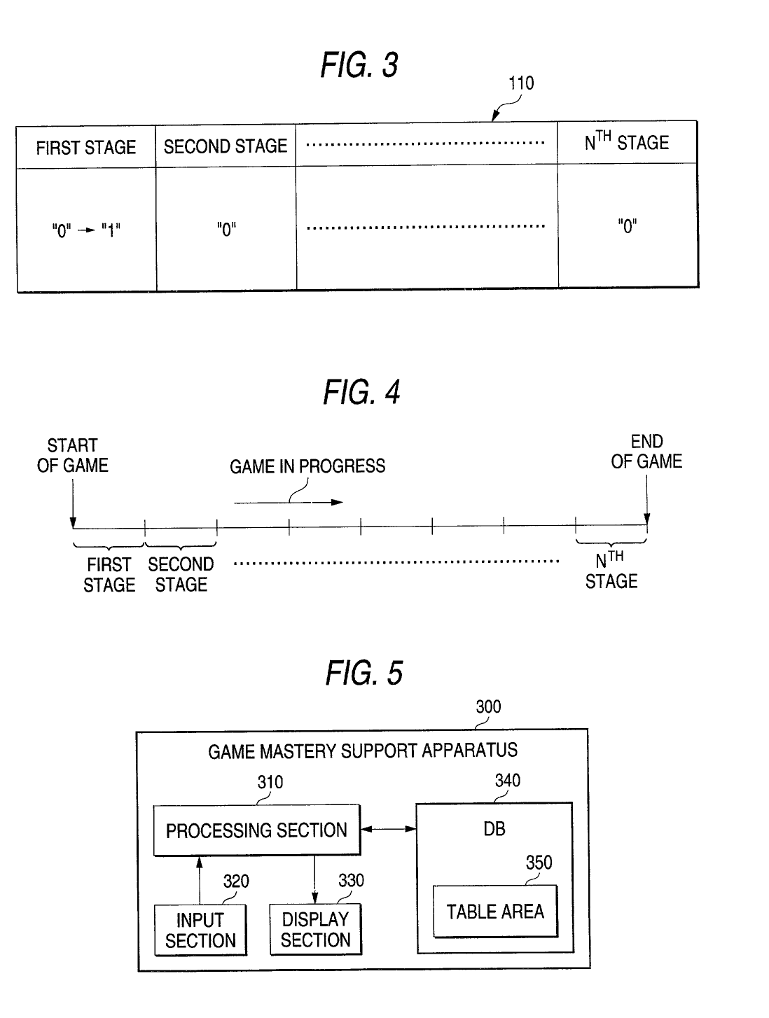

The communications control section 98 performs processing for exchanging required information with the game mastery support apparatus 300 via the communications network 200 (see FIG. 1). The memory card 96 preserves, in a nonvolatile manner, a mastery status flag table 110 (see FIG. 3) for storing game mastery status information periodically written by the CPU 10. FIG. 3 is a descriptive view showing the mastery status flag table 110, and FIG. 4 is a descriptive view for explaining mastery status flag information and mastery information.

As shown in FIG. 4, a game proceeds from a first stage, to a second stage, . . . , to an n^{th} stage. The CPU 10 changes a flag from 0 to 1 in the mastery status flag table 110 at all times in connection with a stage mastered by a player (also called a user). In the example shown in FIG. 3, since a flag in the first stage has been changed from 0 to 1, it is understood that the player has mastered the first stage. If flag information indicating a stage of the game to which the player has proceeded is preserved in the memory card 96, the mastery status information pertaining to a player can be managed with a simple construction.

A processing program 94 for controlling operation of a game machine or effecting communication processing to be described later is recorded in a storage area on the CD-ROM (recording medium) 92. When the CD-ROM 92 is loaded to the CD-ROM driver 60, the CPU 10 operates in accordance with an OS recorded on the ROM 20, loads the processing program 94 read by the CD driver 64, and de-archives the processing program 94 in the RAM 30.

The CPU 10 executes the processing program 94 de-archived in the RAM 30. At this time, a control signal is sent to the voice synthesis CPU 42 or the imaging CPU 52, as required, thereby effecting sound output control operation or display control operation. Thus, a round of control operations of the game machine is performed. Further, the CPU 10 receives an operation signal which pertains to any one of the switches 80 and is output from the controller 80. The CPU 10 performs operation control according with the operation signal, as required. Thus, the game machine performs a round of control operations. Moreover, the CPU 10 performs operation for receiving mastery information output from the game mastery support apparatus 300 in a manner to be described later.

In order to effect a processing routine to be described later, the processing program includes the title of a game, a user ID, etc. The CPU 10 reads these information items and preserves the information items in a predetermined area on the memory card 96 in a nonvolatile manner.

3. Construction of the game mastery support apparatus 300

FIG. 5 is a block diagram showing the game mastery support apparatus 300. The game mastery support apparatus 300 comprises a processing section 310, embodied in a CPU etc., which performs operation in accordance with a processing program; an input section 320 which can be embodied in an input device such as a mouse etc.; a display section 330 which can be embodied in a display device such as a CRT etc.; and a database (DB) 340 which can be embodied in a hard disk drive etc. A table area 350 is formed in the DB 340, and lookup on and updating of a table stored in the table area 350 are effected by the processing section 310.

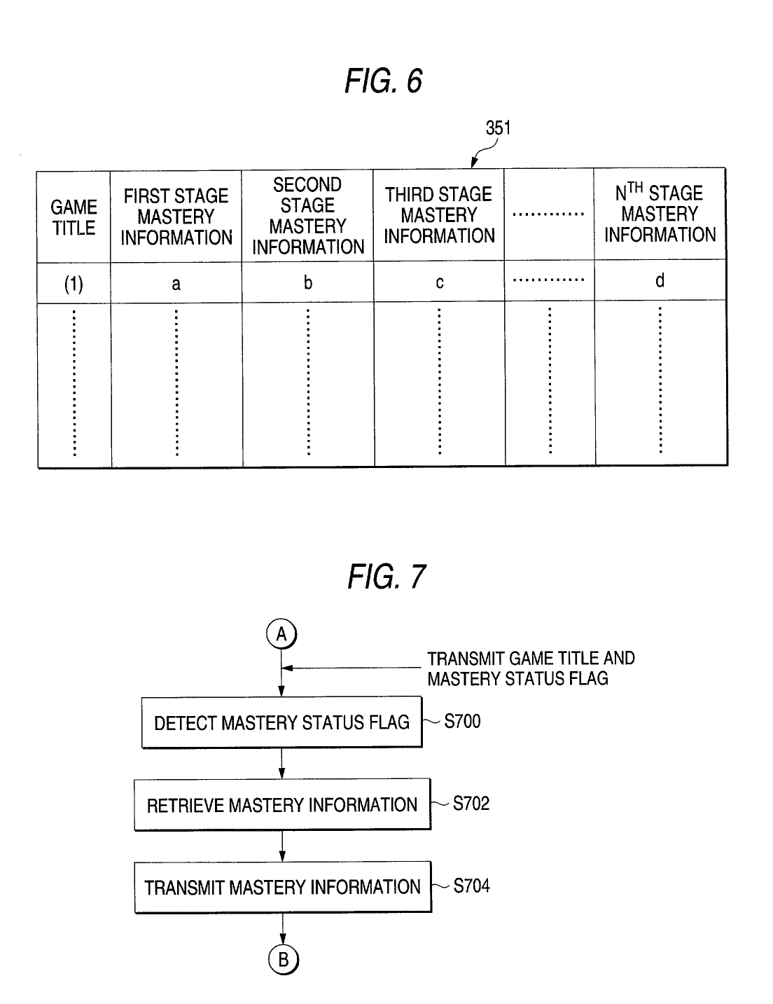

FIG. 6 is a descriptive view showing a mastery information table 351 to be stored in the table area 350. The mastery information table 351 is preserved such that a title of a game is associated with corresponding mastery information items. The mastery information items include first stage mastery information, second stage mastery information, . . . n^{th} stage mastery information.

With reference to FIG. 4, the mastery information items are described. The first stage mastery information is for mastering the first stage. Similarly, the second stage mastery information is for mastering the second stage, and the n^{th} stage mastery information is for mastering then n^{th} stage. In relation to mastery status flags, when only the first stage flag assumes “1,” the first stage has already been mastered, and second stage mastery information (“b” shown in FIG. 6) is distributed.

4. Operation Example 1

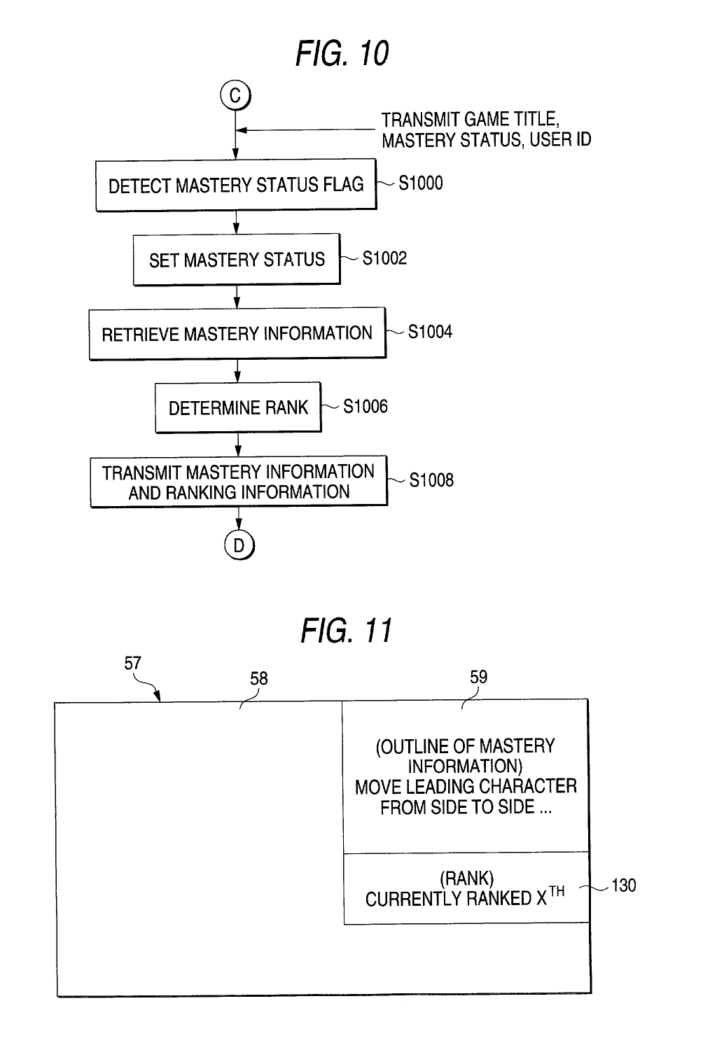

The operation of the game mastery support apparatus will now be described with reference to FIG. 10. The CPU 10 transmits a title of a game and a mastery status flag, which are preserved in the memory card 96, to the game mastery support apparatus 300. In the example shown in FIG. 3, mastery status flags “10 . . . 0” are transmitted.

The processing section 310 of the game mastery support apparatus 300 receives these information items and detects a mastery status flag (step S700). In the example shown in FIG. 3, information items “10 . . . 0” are detected as mastery status flags. In step S702, the processing section 310 retrieves, from the mastery information table 351, mastery information corresponding to the title of a received game and a mastery status flag.

For instance, when only a first flag of mastery status flags assigned to a game title “1” assumes “1,” a first stage of the game is determined to have been mastered. Second stage mastery information; that is, “b” in the example shown in FIG. 6, is retrieved from the mastery information table 351 as mastery information. Even in relation to the same game title “1,” when a mastery status flag assumes “110 . . . 0,” the processing section 310 determines that the first and second stages of the game have been mastered. Accordingly, third stage mastery information; that is, “c” in the example shown in FIG. 6, is retrieved from the mastery information table 351 as mastery information.

In step S704, the processing section 310 distributes the mastery information retrieved in step S702 to the terminal apparatus 100. In response to the distribution, the communications control section 98 of the terminal apparatus 100 receives the mastery information and transfers the thus-received information to the CPU 10. The information is then preserved in the memory card 96 and the RAM 30. Further, the information is transferred to the frame buffer 54, whereupon the imaging CPU 52 performs imaging operation.

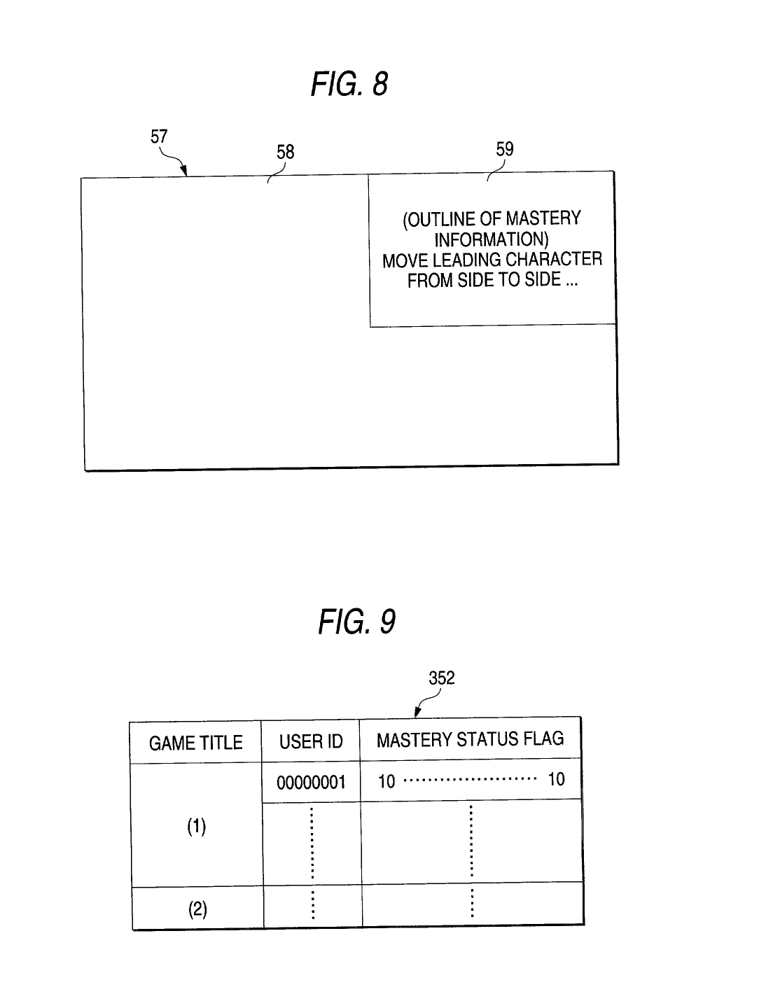

FIG. 8 shows an imaged example performed by the imaging CPU 52. The game screen 58 appears on the display area 57 of the display device 56. When the mastery information is received from the game mastery support apparatus 300, the thus-received mastery information is displayed, more preferably, in an upper right position of the display area 57. Consequently, the mastery information is displayed in an easily-understandable manner during the course of progress of a game. As a result, there is obviated the inconvenience of having to browse through a mastery book, which has been endured hitherto.

Consequently, in Operation Example 1, the game mastery support apparatus 300 distributes mastery information according with a mastery status flag (i.e., mastery status information) indicating a mastered game stage output from the terminal apparatus 100. Hence, the player can, in timely fashion, acquire a required and desired portion of the mastery information, and the thus-acquired information can be displayed on the game screen in an easily understandable manner.

5. Operation Example 2

This operation example is characterized in that a rank of a player is determined on the basis of a mastery status flag and that information pertaining to the rank of the player is also distributed.

FIG. 9 is a descriptive view showing a mastery status management table 352 employed in the present operation example. The table 352 is preserved in the table area 350 of the game mastery support apparatus 300. The mastery status management table 352 stores the title of a game, a user ID serving as a user identifier, and a mastery status flag such that they are associated with each other. In an example shown in FIG. 9, a user ID “00000001” assigned to a game title (1) has a mastery status flag of “10 . . . 0.” As has been described previously, the processing section 310 stores a mastery status flag, which has been transmitted from the terminal apparatus 100, into a corresponding area on the mastery status management table 352.

The operation of the game mastery support apparatus will now be described with reference to FIG. 10. When a player issues an instruction pertaining to a mastery information distribution by actuation of the controller 80, the control CPU 10 transmits to the game mastery support apparatus 300 the title of a game, the mastery status flag, and the user ID, which have been stored in the memory card 96. In the example shown in FIG. 3, a mastery status flag “10 . . . 0” is transmitted to the game mastery support apparatus 300.

The processing section 310 of the game mastery support apparatus 300 receives the thus-transmitted information and detects the mastery status flag (step S1000) . In the example shown in FIG. 3, “10 . . . 0” is detected as the mastery status flag. In step S1002, the processing section 310 sets the received mastery status flag in a mastery status flag storage area corresponding to the received game title and user ID, within the mastery status management table 352.

In step S1004, the processing section 310 retrieves mastery information corresponding to the received game title and mastery status flag from the mastery information table 351 employed in the previous operation example. For example, when only the first flag of mastery status flag assigned to the game title (1) assumes “1,” the first stage is determined to have been mastered. Accordingly, second stage mastery information; e.g., “b” in the example shown in FIG. 6, is retrieved from the mastery information table 351 as mastery information.

In step S1006, the processing section 310 looks up all mastery status flags relating to the game title (e.g., game title (1)) in the mastery status management table 352 and performs processing for ranking users in descending order from the user who has proceeded to the highest stage of the game (1). At this time, the same rank is assigned to users who have proceeded to the same stage. Alternatively, users who have proceeded to the same stage of the game may be ranked according to a play time.

In step S1008, the processing section 310 distributes, to the terminal apparatus 100, mastery information retrieved in step S1004 and ranking information determined in step S1006. In response, the communications control section 98 of the terminal apparatus 100 receives these information items and transfers the thus-received information items to the control CPU 10. The information items are then preserved in the memory card 96 and the RAM 30. Further, the information items are transferred to the frame buffer 54, where the imaging CPU 52 subjects the information items to imaging.

FIG. 11 shows an imaged example produced by the imaging CPU 52. The game screen 58 appears on the display area 57 of the display device 56. Upon receipt of mastery information from the game mastery support apparatus 300, the imaging CPU 52 displays the thus-received mastery information in an upper left position in the display area 57 and displays ranking information (e.g., a message stating that your current rank is X^{th}). Thus, ranking information as well as mastery information can be displayed so as to be readily readable for the player during the course of progress of a game, thereby giving the player another incentive to playing the game.

Further, the processing section 310 accumulates mastery status information output from the terminal apparatus 100 in the mastery status management table 352 for each user ID. With reference to the thus-accumulated mastery status information, a corresponding user is ranked. Ranking information can be distributed to the player through simple processing for merely distributing ranking information pertaining to the thus-determined rank.

In the embodiment of the present invention as has been described above, the game mastery support apparatus 300 distributes mastery information for mastering a game to the terminal apparatus 100 having a game execution function, whereby the player can receive the thus-distributed mastery information.

The terminal apparatus 100 can be embodied in, e.g., a portable cellular phone or a portable device having a mobile function such as a compact information processor etc. Here, in a case where the terminal apparatus 100 is embodied in a portable cellular phone, the construction of the game mastery support system shown in FIG. 1 must include an intermediary apparatus such as a base station etc. If the terminal apparatus 100 is embodied not in a stationary apparatus but in a portable device, there is obviated a necessity of carrying a mastery book, thus improving convenience of the player to a much greater extent.

6. Another Embodiment

The present embodiment is characterized in that a terminal apparatus having a game execution function is separated from another terminal apparatus for receiving mastery information. FIG. 13 shows the construction of a game mastery support system according to another embodiment of the present invention. Here, a terminal apparatus 100a is connected to the communications network 200 and has a game function. Further, the terminal apparatus 100a is connected so as to be able to exchange required information with the game mastery support apparatus 300 via the communications network 200. Another terminal apparatus 100b corresponds to a compact information processor featuring mobility, a portable cellular phone having a transceiver function for sending/receiving various kinds of information items, and a portable device such as a personal handy phone system (i.e., PHS) etc.

In this case, a mastery status flag transmitted from the terminal apparatus 100a is received by the game mastery support apparatus 300 along with a transmission address of the terminal apparatus 100b. The game mastery support apparatus 300 transmits mastery information corresponding to a mastery status flag to the terminal apparatus 100b which is, for example, a portable cellular phone specified by the transmission address. As a result thereof, the terminal apparatus 100b stores mastery information in memory thereof and displays the mastery information on a display area thereof.

Consequently, in the embodiment, the player can play a game while viewing a game screen of the terminal apparatus 100a and looking up the mastery information appearing on the terminal apparatus 100b. In contrast with a case where a game screen and mastery information are displayed on the same screen, a display area for mastery information can be sufficiently ensured, thus preventing the player from encountering difficulty in viewing the game screen.

7. Another Embodiment

Further, another embodiment of the present invention is considered as follows:

(1) Retrieval Function

Retrieval data which are objects of retrieval are stored in the DB 340 of the game mastery support apparatus 300, and the processing section 310 has a retrieval engine function. The processing section 310 retrieves data stored in the DB 340, through use of a retrieval keyword imparted to the processing section 310 from the terminal apparatus 100, and distributes a result of retrieval. At this time, the processing section 310 retrieves data such that the volume of retrievable data is controlled in accordance with a mastery status flag transmitted from the terminal apparatus 100. Conceivable retrieval data include arbitrary names appearing during a game; such as unofficial techniques of items employed in a game, locations to be mastered, titles of scenes, and challenging characters (names of opponent characters).

For instance, when the player enters “Unofficial techniques,” mastery information items whose titles include the term “unofficial technique” are retrieved, and the thus-retrieved information items can be distributed. Objects of retrieval are defined strictly in accordance with a master status flag. Hence, as the player advances to higher stages, the volume of retrieval result increases. Further, the processing section 310 can impose limitations on retrieval keywords in accordance with lapse of time since the game has been released.

(2) User Management Function

So long as the processing section 310 prompts the user to enter user information, such as a gender, an age, an electronic mail address (i.e., e-mail address), etc., when the user has requested mastery information and the thus-entered user information is accumulated in the DB 340, a customer information DB will be constructed. If particularly e-mail addresses of users are accumulated, a debugged program and advertisement information pertaining to new products can be automatically distributed to the users. Moreover, the processing section 310 can automatically distribute data pertaining to rarity added value information to higher-ranked users via e-mails. Furthermore, if a distribution history of mastery information is accumulated on a per-user basis, distribution information can be customized for each user.

(3) Flag Information

In the embodiment, a timing at which a mastery status flag is to be transmitted to the game mastery support apparatus 300 is determined by the player's willingness. However, transmission of a mastery status flag to the game mastery support apparatus 300 may be effected at predetermined time intervals. Further, ranking information may be provided for a predetermined number of players who have first advanced to a certain stage, for each stage determined by the pattern of a mastery status flag.

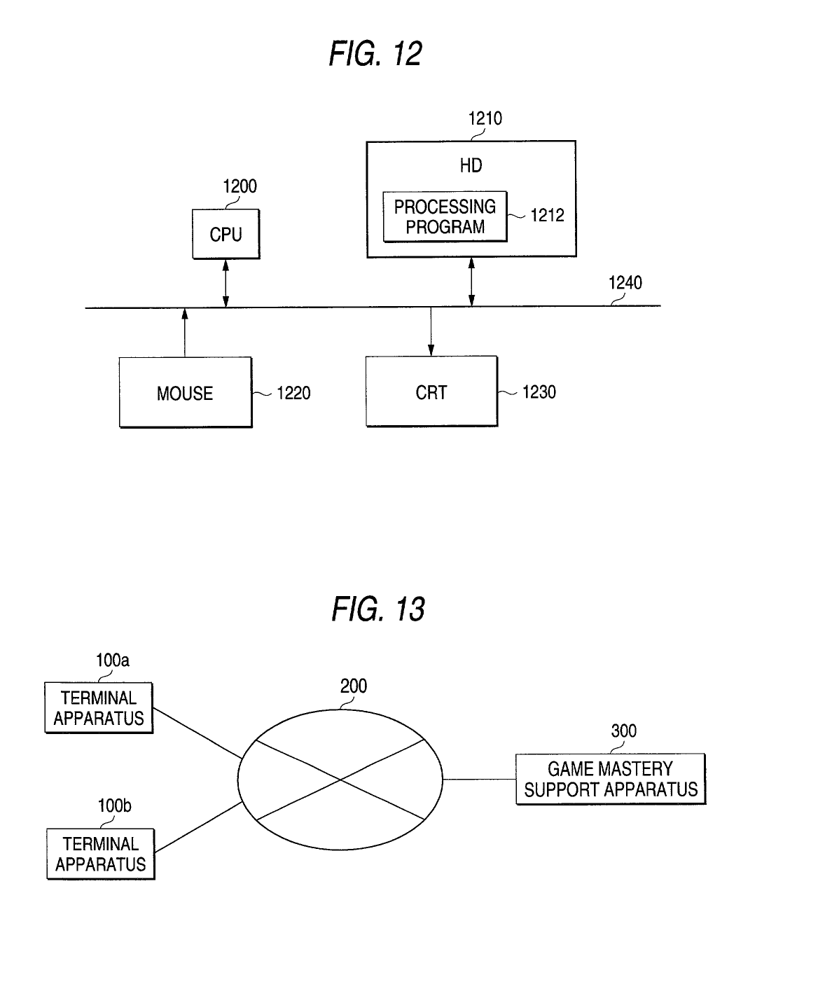

FIG. 12 is a block diagram showing hardware configuration of the game mastery support apparatus 300 shown in FIG. 1. As shown in the configuration shown in FIG. 12, the game mastery support apparatus 300 includes a CPU 1200, a hard disk drive (HD) 1210 having recorded thereon a processing program 1212, a mouse 1220, and a CRT 1230. These elements are connected to a bus 1240 so as to be able to mutually exchange required information. The CPU 1200 executes the processing program 1212, thereby effecting the various operations mentioned previously.

The embodiments of the present invention have been described. The embodiments of the present invention may be susceptible to various modifications or alterations within the scope of the invention. For instance, audible notification may be issued for prompting the player to perform operation at the time of transmission or receipt of information pertaining to the terminal apparatus 100. The player may not be allowed to perform a round of operations without entering a password or a PIN number by the terminal apparatus 100. Mastery information and ranking information may be provided through voice synthesis. Mastery information and ranking information may be displayed in a manner different from that shown in FIGS. 8 and 11. Mastery information to be stored in the mastery information table 351 may be updated (added or changed), as required. Thus, various modifications or alterations can be implemented.

As has been described, mastery information for mastering a game is distributed to a terminal apparatus having a game execution function. Hence, the present invention yields an advantage of ability to enable a player to receive mastery information.

8. Overall Supplement

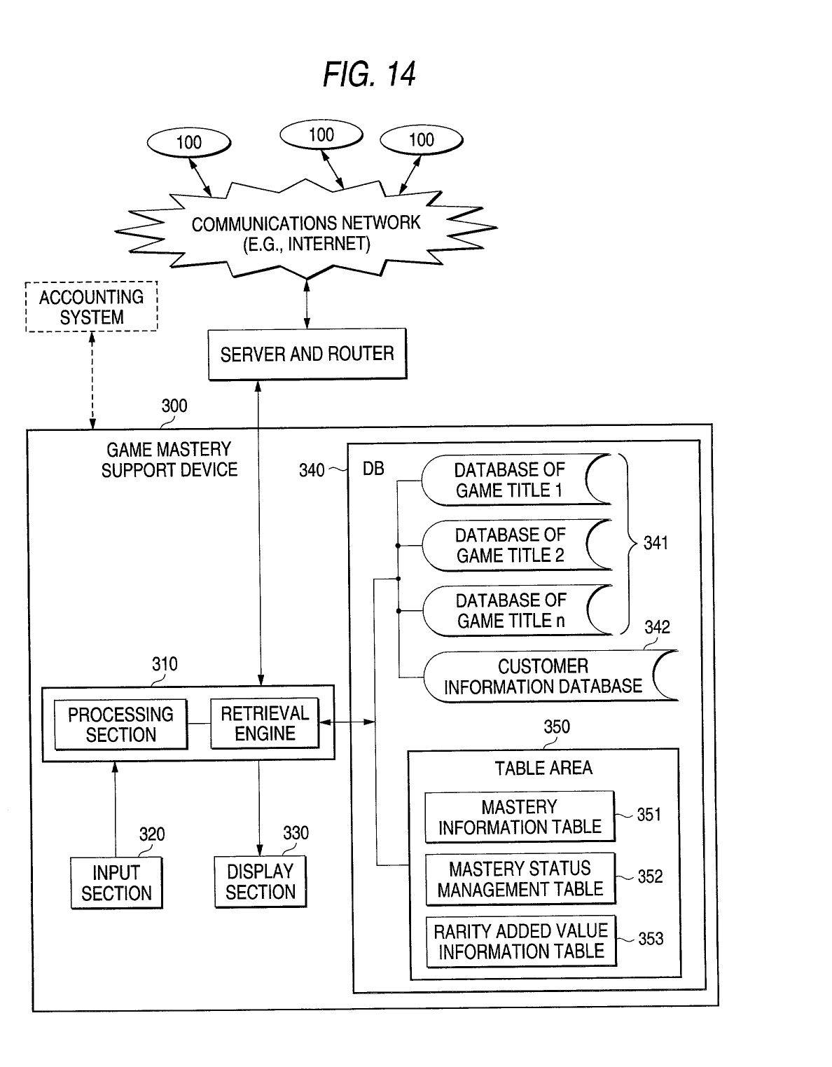

The respective embodiments of the present invention are expected to create new business models. FIG. 14 is a block diagram showing one example of a business method for distributing mastery information for mastering a game (hereinafter called “game mastery information”). Several features of the foregoing embodiments are consolidated into this example. Each of terminal apparatuses 100 used by a plurality of users (i.e., a plurality of players) has a game execution function and is capable of exchanging information about games by utilization of a communications network such as the Internet. The memory card 96 of the terminal apparatus 100 (see FIG. 2) can preserve user information items; for example, a game title, a game mastery status flag, a user ID serving as a user identifier, and detailed personal user information (e.g., a name, a sex, a birth date, an age, an address, a phone number, an e-mail address, etc.). When the user has instructed a distribution of game mastery information by way of actuation of the controller 80 (see FIG. 2), the CPU 10 for controlling the entire terminal apparatus performs control operation such that the mastery status flag stored in the memory card 96 is transmitted to the game mastery support apparatus 300. At this time, the user information items including a game title, a game mastery status flag, and a user ID can also be transmitted simultaneously. So long as the user has entered detailed personal user information items to the terminal apparatus 100 beforehand, the information items are stored as data in the memory card 96. Accordingly, when the user instructs a distribution of game mastery information, a necessity for re-entering personal user information is obviated. If there is a necessity for modifying the personal user information stored in the memory card 96, the only requirement is that the user should modify required information item as occasion demands.

In this way, the user information items are transmitted to the game mastery support apparatus 300 from the terminal apparatus 100 via a communications network, a server, and a router, as shown in FIG. 14. The game mastery support apparatus 300 that has received the user information items retrieves game mastery information (see FIGS. 4 and 6) corresponding to the name of the game and the mastery status flag that have been sent from the user. The retrieval operation is performed by a processing section 310 of the game mastery support apparatus 300 retrieving mastery information table 351 provided in the DB 340 through use of a retrieval engine function of the processing section 310. Subsequently, the thus-retrieved mastery information corresponding to the game title and the mastery status flag is distributed to the terminal apparatus 100. The DB 340 has a DB group 341 having stored therein the game titles and corresponding game information items. The processing section 310 retrieves game information items corresponding to the received game title, and the thus-retrieved game information items can be distributed to the terminal apparatus 100. Accordingly, the user can readily acquire mastery information corresponding to the status of progress of a game. There are obviated a necessity of carrying a mastery book for mastering a game and a necessity of retrieving mastery information described in the book in accordance with a stage to be mastered.

The received user information items are stored in the DB 340, thereby constructing customer information DB 342. If user information, such as a name, a sex, a birth date, an age, an address, a phone number, an e-mail address, etc., has not been stored in the DB 340, the processing section 310 prompts the user to enter the required user information when the user demands mastery information. The user information is acquired in this way and stored in the DB 340, whereby customer information DB is constructed. Particularly, if the user's e-mail address has been stored in the DB 340, there is conceived service of automatically distributing, e.g., a debugged program, advertisement information regarding new products, etc., in the form of an e-mail. Such the service takes into account customer relationship management (CRM). There is also conceived service of the processing section 310 automatically distributing rarity added value information to higher-ranked users in the form of e-mails. Moreover, there is conceived service of storing a distribution history of mastery information into the DB 340 on a per-user basis, distribution information can be customized for each user. As a matter of course, a system for accounting mastery information distribution service may be incorporated into the block diagram shown in FIG. 14. An example of such a accounting system is indicated by use of dotted lines shown in FIG. 14.

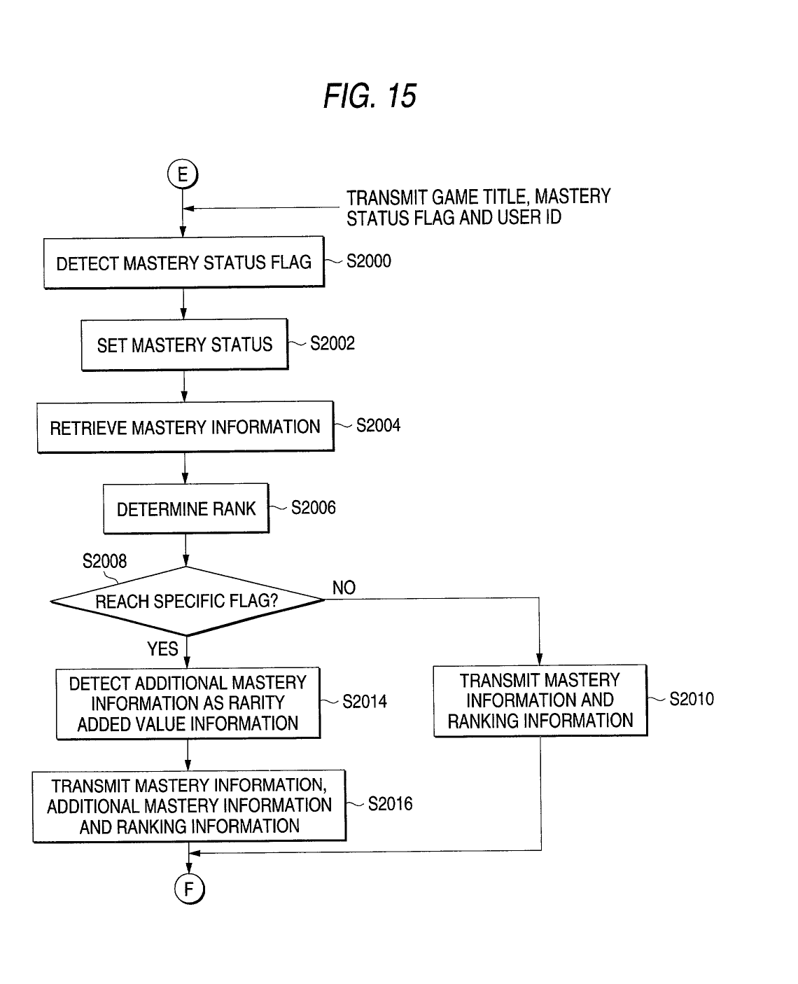

The operation of the system having the construction shown in FIG. 14 is described with reference to a flowchart shown in FIG. 15. When the user instructs a distribution of mastery information by a user actuating the controller 80, the CPU 10 transmits, to the game mastery support apparatus 300, the game title, the mastery status flag, and a user ID, stored in the memory card 96. In the example shown in FIG. 3, a mastery status flag “10 . . . 0.”

The processing section 310 of the game mastery support apparatus 300 receives the information (i.e., the game title, the mastery status flag, and the user ID), and detects a mastery status flag (step S2000). In the example shown in FIG. 3, “10 . . . 0” is detected as a mastery status flag. In step S2002, the processing section 310 sets the received mastery status flag in a mastery status flag storage area corresponding to the received game title and user ID, within the mastery status management table 352 used in the previous operation examples.

Next, in step S2004, the processing section 310 retrieves mastery information corresponding to the received game title and mastery status flag, from the mastery information table 351 employed in the previous operation examples. For example, when only the first flag of mastery status flag assigned to the game title (1) assumes “1,” the first stage is determined to have been mastered. Accordingly, second stage mastery information; e.g., “b” in the example shown in FIG. 6, is retrieved from the mastery information table 351 as mastery information.

In step S2006, the processing section 310 looks up all mastery status flags relating to the game title (e.g., game title (1)) in the mastery status management table 352 and performs processing for ranking users in descending order from the user who has proceeded to the highest stage of the game (1). At this time, the same rank is assigned to users who have proceeded to the same stage. Alternatively, users who have proceeded to the same stage of the game may be ranked according to a play time.

In step S2008, a determination is made as to whether or not a mastery status flag has achieved a specific mastery flag or a higher flag. In other words, in step S2008, a determination is made as to whether or not a mastery progress has achieved a certain level or a higher level. Provided that the level is taken as a second stage with reference to FIG. 4, YES is selected if the received mastery status flag shows the second stage or a higher stage. The processing routine then proceeds to step S2014. On the other hand, NO is selected if the received mastery status flag shows a first stage. The processing routine then proceeds to step S2010. As a matter of course, the processing routine pertaining to step S2008 may be performed on the basis of a rank pertaining to a game mastery progress determined in step S2006. More specifically, in step S2008 a determination may be made as to whether or not the user is assigned a corresponding rank, provided that the user is ranked stage 2 or a higher stage.

In step S2010, the processing section 310 distributes, to the terminal apparatus 100, mastery information retrieved in step S2004 and the rank information determined in step S2006. In response to this, the communications control section 98 of the terminal apparatus 100 receives the information and transfers the received information to the CPU 10. The information is preserved in the memory card 96 and the RAM 30. The information is then sent to the frame buffer 54, thereby causing the imaging CPU 52 to perform an imaging operation.

In step S2014, the processing section 310 retrieves additional mastery information from rarity added value information table 353 of the DB 340 as rarity added value information. Conceivable additional mastery information is one which is not stored in the mastery information table 351 and has a rarity added value; e.g., unofficial techniques of items as has been described above.

In step S2016, the processing section 310 distributes, to the terminal apparatus 100, the mastery information retrieved in step S2004, the additional mastery information retrieved instep S2014, and the rank information determined in step S2006. In response to this, the communication control section 98 of the terminal apparatus 100 receives the information and transfers the received information to the CPU 10. The information is then preserved in the memory card 96 and the RAM 30. The information is further sent to the frame buffer 54, thereby causing the imaging CPU 52 to perform an imaging operation.

In such an operation example, in at least either a case where the received mastery status flag has achieved a specific mastery flag or where a rank of game master progress is higher than a specific rank, there is acquired rarity added value information in addition to usually-acquired mastery information. Accordingly, it is predicted that a user strives to acquire rarity added value information, which would be acquired only when a certain level has been achieved. Hence, it can be expected that interest in the game can be increased. Further, a routine for accounting mastery information distribution service may be taken into the flowchart shown in FIG. 15.

It is contemplated that numerous modifications may be made to the game mastery support apparatus, the terminal apparatus, the recording medium, such as a computer readable medium, having recorded thereon a processing program for use with the game mastery support apparatus and the terminal apparatus, of the present invention without departing from the spirit and scope of the invention as defined in the following claims.

What is claimed is:

1. A game mastery support apparatus which supports mastery of a game, the game mastery support apparatus comprising:
a distribution device which distributes mastery information for mastering a game to a terminal apparatus having a game execution function.

2. The game mastery support apparatus according to claim 1, wherein the distribution device distributes the mastery information according to mastery status information, which is obtained from the terminal apparatus and indicates a stage of the game to which a player has proceeded.

3. The game mastery support apparatus according to claim 2, wherein the mastery status information from the terminal apparatus includes flag information indicating a stage of the game to which the player has proceeded.

4. The game mastery support apparatus according to claim 1, further comprising:
a ranking information distribution device which distributes ranking information pertaining to a rank of a player in the game.

5. The game mastery support apparatus according to claim 2, further comprising:
a ranking information distribution device which distributes ranking information pertaining to a rank of a player in the game.

6. The game mastery support apparatus according to claim 3, further comprising:
a ranking information distribution device which distributes ranking information pertaining to a rank of a player in the game.

7. The game mastery support apparatus according to claim 4, wherein the ranking information distribution device includes:
an accumulator which accumulates the mastery status information from the terminal apparatus for each player's identifier;
a determining device which determines a rank of a corresponding user with reference to the accumulated mastery status information; and
a distributor which distributes ranking information pertaining to the determined rank.

8. The game mastery support apparatus according to claim 5, wherein the ranking information distribution device includes:
an accumulator which accumulates the mastery status information from the terminal apparatus for each player's identifier;
a determining device which determines a rank of a corresponding user with reference to the accumulated mastery status information; and
a distributor which distributes ranking information pertaining to the determined rank.

9. The game mastery support apparatus according to claim 6, wherein the ranking information distribution device includes:
an accumulator which accumulates the mastery status information from the terminal apparatus for each player's identifier;
a determining device which determines a rank of a corresponding user with reference to the accumulated mastery status information; and
a distributor which distributes ranking information pertaining to the determined rank.

10. The game mastery support apparatus according to claim 4, wherein the terminal apparatus comprises a first terminal device having a game execution function, and a second terminal device displaying received mastery information within a display area thereof, wherein the game mastery support apparatus further comprises:
a receiver which receives, from the first terminal device, mastery status information representing a game stage to be mastered; and
a distributing device which distributes, to the second terminal device specified as a destination, the mastery information and the ranking information according to the mastery status information from the first terminal device.

11. The game mastery support apparatus according to claim 5, wherein the terminal apparatus comprises a first terminal device having a game execution function, and a second terminal device displaying received mastery information within a display area thereof, wherein the game mastery support apparatus further comprises:
a receiver which receives, from the first terminal device, mastery status information representing a game stage to be mastered; and
a distributing device which distributes, to the second terminal device specified as a destination, the mastery information and the ranking information according to the mastery status information from the first terminal device.

12. The game mastery support apparatus according to claim 6, wherein the terminal apparatus comprises a first terminal device having a game execution function, and a second terminal device displaying received mastery information within a display area thereof, wherein the game mastery support apparatus further comprises:
a receiver which receives, from the first terminal device, mastery status information representing a game stage to be mastered; and
a distributing device which distributes, to the second terminal device specified as a destination, the mastery information and the ranking information according to the mastery status information from the first terminal device.

13. The game mastery support apparatus according to claim 1, wherein the terminal apparatus is a portable device.

14. The game mastery support apparatus according to claim 10, wherein the first terminal apparatus and the second terminal apparatus are portable devices.

15. The game mastery support apparatus according to claim 11, wherein the first terminal apparatus and the second terminal apparatus are portable devices.

16. The game mastery support apparatus according to claim 12, wherein the first terminal apparatus and the second terminal apparatus are portable devices.

17. A terminal apparatus which receives information distributed by a game mastery support apparatus for supporting mastery of a game, and which has a game execution function, the terminal apparatus comprising:
a display screen; and
a processing section which receives, from the game mastery support apparatus, distributed mastery information for mastering a game, and which displays the mastery information on the display screen.

18. The terminal apparatus according to claim 17, wherein the processing section receives, from the game mastery support apparatus, distributed ranking information pertaining to a rank of a player in the game, and which displays the ranking information on the display screen.

19. The terminal apparatus according to claim 17, further comprising:
a first terminal device which has the game execution function, and which sends, to the game mastery support apparatus, mastery status information representing a game stage to be mastered; and
a second terminal device which receives information distributed by the game mastery support apparatus, and which is specified as a destination of the mastery information,
wherein the second terminal device includes:
the display screen, and
the processing section receiving, from the game mastery support apparatus, the mastery information for mastering the game, and displaying the mastery information on the display screen.

20. The terminal apparatus according to claim 19, wherein the processing section receives, from the game mastery support apparatus, distributed ranking information pertaining to a rank of a player in the game, and which displays the ranking information on the display screen.

21. The terminal apparatus according to claim 17, wherein the terminal apparatus is a portable device.

22. The terminal apparatus according to claim 19, wherein the first terminal apparatus and the second terminal apparatus are portable devices.

23. A computer readable medium having recorded thereon a processing program for activating a game mastery support apparatus for supporting mastery of a game, the processing program comprising:
a distributing routine for distributing mastery information for mastering a game to a terminal apparatus having a game execution function.

24. A method for distributing, via a communications network, game mastery information from a game mastery support apparatus to a terminal apparatus having a game execution function in accordance with a request from the terminal apparatus, the method comprising the steps of:
storing, in the terminal apparatus, user information items including a game title, mastery information flag pertaining to a game stage to be mastered, a user identifier, and personal user information;
transmitting the user information items to the game mastery support apparatus;
causing a processing section of the game mastery support apparatus to retrieve mastery information corresponding to the received game title and mastery information flag from a mastery information table of the game mastery support apparatus;
storing the received mastery information flag as mastery status information to a mastery status management table of the game mastery support apparatus on a per-user-identifier basis;
causing the processing section of the game mastery support apparatus to retrieve the game information items corresponding to the received game title from a game title data base group of the game master support apparatus;
causing the processing section to store the received personal user information as customer information database;
determining a rank of a corresponding user with reference to the stored mastery status information; and
distributing, to the terminal apparatus, mastery information corresponding to mastery status information on the game stage to be mastered, and the determined user rank information.

25. The method according to claim 24, further comprising the steps of:
distributing rarity added value information from the game mastery support apparatus to the terminal apparatus of a higher-ranked user; and
storing a mastery status information distribution history in the game mastery support apparatus on a per-user basis, thereby customizing a delivery status for each user.
